(19) United States
(12) Patent Application Publication
(10) Pub. No.: US 2003/0101058 A1
(43) Pub. Date: May 29, 2003

(54) Voice barcode scan device

(76) Inventors: Kenneth Liou, Taipei Hsien (TW); Kuo-Nien Liu, Taipei Hsien (TW)

Correspondence Address: RABIN & BERDO, P.C., Suite 500, 1101 14th Street, N.W., Washington, DC, 20005, US

(21) Appl. No.: 10/151,026

(22) Filed: May 21, 2002

(30) Foreign Application Priority Data
Nov. 26, 2001 (TW) 090129224

(51) Int. Cl. G10L 21/00

(52) U.S. Cl. 704/272

(57) ABSTRACT

A voice barcode scan device includes a barcode scan unit, a microprocessor, a memory unit, a voice-processing unit and a voice output unit. The memory unit stores different voice signals according to different addresses. The barcode scan unit reads the address from the barcode label and fetches the corresponding digital voice signals from the memory unit. The accessed voice signals are processed and converted to analog signals by the voice-processing unit. The analog voice signals are output from the speaker or earphones to achieve the voice education, entertainment or security purposes.

### BACKGROUND OF THE INVENTION

I. Field of the Invention

This invention relates generally to a voice barcode scan device and, more specifically, to a voice barcode scan device that reads the barcode label representing a figure or a word and then output corresponding voices from the speaker or earphone to achieve the voice education, entertainment or security purposes.

II. Description of the Prior Art

General children-learning machines with voice and picture cards need adult accompanied to guide and instruct, while adult is not around, children can not operate the learning-machines independently and lose the interest of learning. Another type of children-learning machines have pictures on panel, a push button circuitry is beneath each picture, the push button circuitry connects to a voice circuitry to output the corresponding sound. However, such learning-machines have limited pictures and materials for children to learn. Children might also lose attention to the dull and simple functions, the machines might obsolete very soon. To buy one machine is not easy to achieve the learning effect, to buy multiple machines will cause duplication of the machine bodies, voice IC's, voice output circuitry's and speakers that further causes material, economic waste and environmental pollution while those machines are disposed.

### SUMMARY OF THE INVENTION

It is therefore a primary object of the present invention to provide a voice barcode scan device to have a barcode label under every picture and word. The barcode label contains an address corresponding to a voice signal. A barcode reader scans the data from barcode label, fetches the corresponding voice message and plays the voice message with a speaker or earphone.

It is a further objective of the present invention to provide a voice barcode scan device in which a voice-input unit is connected to input and store the voice signals into the memory unit. Users can edit the address locations to record a paragraph or a word into the memory unit for more practical application.

It is still a further objective of the present invention to provide a voice barcode scan device as a language-learning machine, a toy for children, a security system or other automation equipment.

In order to achieve the objective set forth, a voice barcode scan device in accordance with the present invention comprises a barcode scan unit, a microprocessor, a memory unit, a voice-processing unit and a voice output unit. The barcode scan unit consists of a light source, a lens, and a CCD or CMOS image sensor. The barcode scan unit reads the reflected image from the barcode label and converts the image into digital signals and sends the signals to the microprocessor. The microprocessor connects and controls all the units by program. The memory unit connects to the microprocessor. The microprocessor fetches the stored multiple voice information with the addresses scanned. The voice-processing unit is connected to the output port of the microprocessor. The voice-processing unit converts the digital voice signals into analog voice signals, or converts analog voice signals to digital voice signals. The voice output unit consists of a voice output interface, a signal amplifier and a speaker. The voice output unit is connected to the output port of the voice-processing unit, and amplifies the analog voice signals to the speaker to output the sound stored. The voice output unit can also connects to the earphone between the signal amplifier and the speaker for individual usage; the volume output can be adjusted with the amplifier. A voice-input unit is connected to the voice-processing unit. The voice-input unit consists of a microphone, a signal amplifier and a voice-input interface; the voice-input unit can input and store the voice signals into the memory unit.

When the power supply is turned on, users can take the barcode scan unit and aim at the barcode label to read the data. The microprocessor receives the data and converts those into the addresses of the memory unit and fetches the corresponding voice signals. The voice signals are sent to the voice-processing unit and converted into analog format. The voice output unit amplifies the analog signals; the amplified analog signals are output from the speaker. Children can operate and learn by themselves. Such device can apply to toys for children or security system and other automation equipment.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a circuit diagram of an embodiment of the present invention;

FIG. 2 is a circuit diagram of another embodiment of the present invention.

### DESCRIPTION OF THE PREFERRED EMBODIMENT

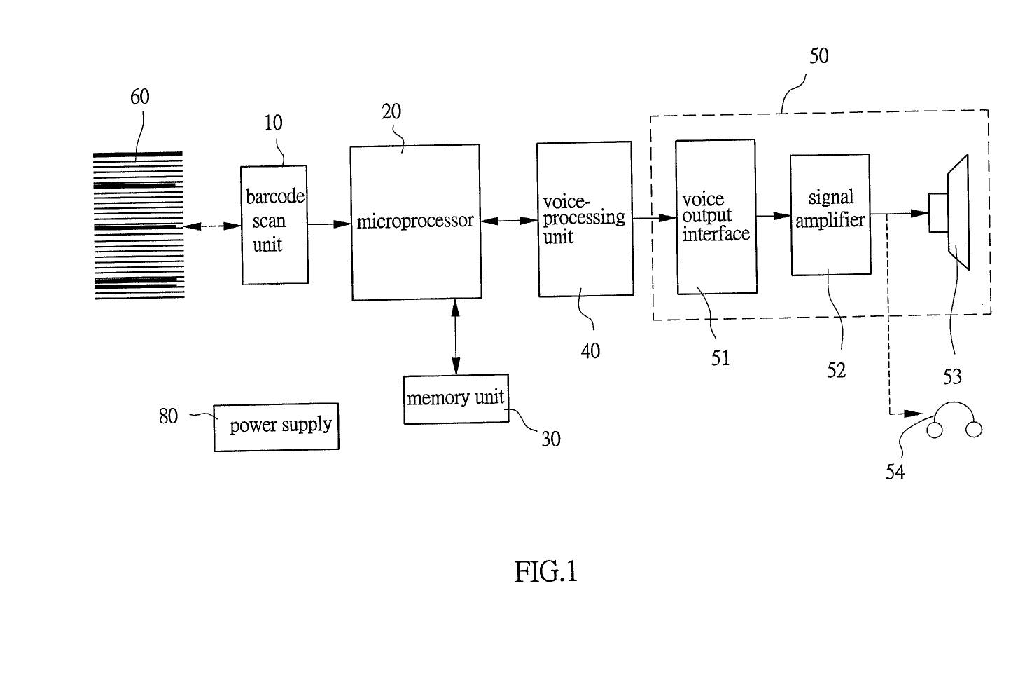

Referring to FIG. 1, the present invention is composed of a barcode scan unit 10, a microprocessor 20, a memory unit 30, a voice-processing unit 40 and a voice output unit 50. The functions of each component are described below:

The barcode scan unit 10 consists of a light source, a lens and a CCD or CMOS image sensor. The barcode scan unit 10 reads the reflected image from the barcode label 60, converts the image into digital signals and sends the signals to the microprocessor 20.

The microprocessor 20 connects and controls all the units by program.

The memory unit 30 connects to the microprocessor 20. The microprocessor 20 fetches the stored multiple voice information with the addresses scanned.

The voice-processing unit 40 is connected to the output port of the microprocessor 20. The voice-processing unit 40 converts the digital voice signals into analog voice signals, or converts analog voice signals to digital voice signals.

The voice output unit 50 consists of a voice output interface 51, a signal amplifier 52 and a speaker 53. The voice output unit 50 is connected to the output port of the voice-processing unit 40, and amplifies the analog voice signals to the speaker 53 to output the sound stored. The voice output unit 50 can also connect to the earphone 54 between the signal amplifier 52 and the speaker 53 for individual usage. The volume output can be adjusted with the amplifier 52.

Based on above structure, when the power supply 80 is turned on, users can take the barcode scan unit 10 and aim at the barcode label 60 to read the data. The microprocessor 20 receives the data and converts those into the addresses of the memory unit 30 and fetches the corresponding voice signals. The voice signals are sent to the voice-processing unit 40 and converted into analog format. The voice output unit 50 amplifies the analog signals; the amplified analog signals are output from the speaker 53. Children can operate and learn by themselves. Such device can apply to toys for children or security system and other automation equipment.

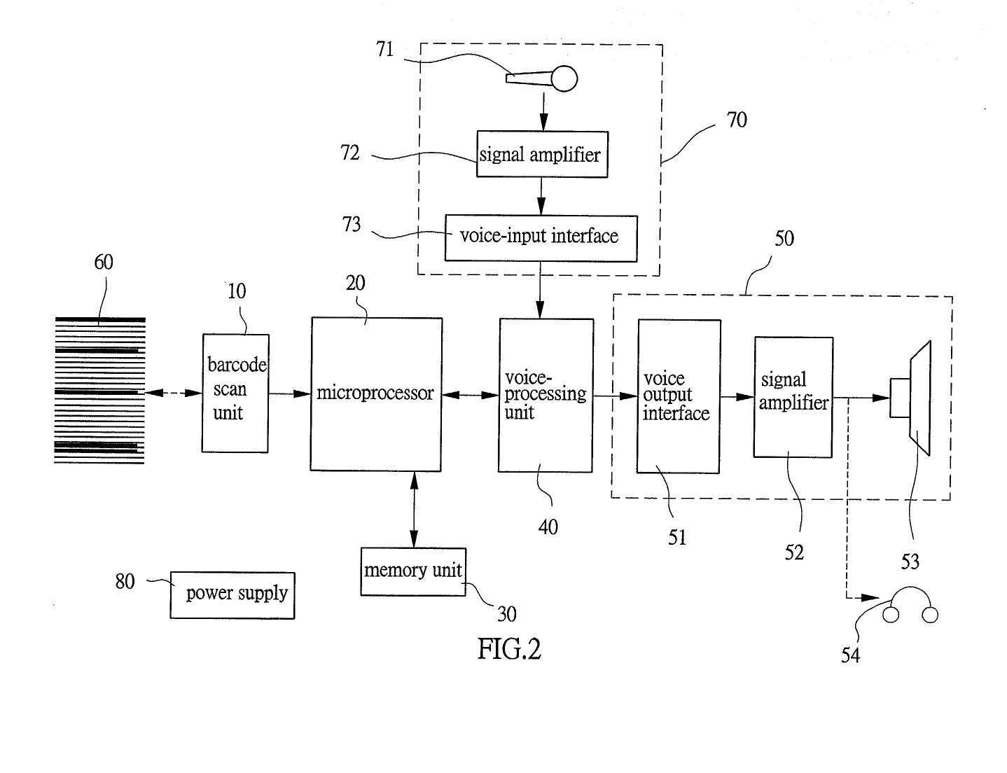

Referring to FIG. 2, a voice-input unit 70 is connected to the voice-processing unit 40. The voice-input unit 70 consists of a microphone 71, a signal amplifier 72 and a voice-input interface 73; the voice-input unit 70 can input and store the voice signals into the memory unit 30. The voice-input unit 70 can record a second language or sound at the same address to conduct bilingual instruction to achieve more fun and more novelty.

The memory unit 30 can be in inserting card format, such format can achieve more storage, and users can categorize the memory unit 30 based on different contents for different application.

While a preferred embodiment of the invention has been shown and described in detail, it will be readily understood and appreciated that numerous omissions, changes and additions may be made without departing from the spirit and scope of the invention.

What is claimed is:

1. A voice barcode scan device comprising:
a microprocessor connecting, controlling the internal units and executing the program;
a barcode scan unit consisting of a light source, a lens and a CCD or CMOS image sensor, said barcode scan unit reads the reflected image from the barcode label, converts the image into digital signals and sends the signals to said microprocessor;
a memory unit connecting to said microprocessor, said microprocessor fetches the stored multiple voice information from said memory unit with the addresses scanned;
a voice-processing unit connected to the output port of said microprocessor, said voice-processing unit converts the digital voice signals into analog voice signals, or converts analog voice signals to digital voice signals;
a voice output unit consisting of a voice output interface, a signal amplifier and a speaker, said voice output unit is connected to the output port of said voice-processing unit, and amplifies the analog voice signals to said speaker to output the sound stored;
wherein said voice barcode scan device aims at and injects light to a barcode label, reads the reflected signals, the reflected signals are processed by said microprocessor, said memory unit, said voice-processing and said voice output unit to output the corresponding voice through a speaker.

2. The voice barcode scan device recited in claim 1, wherein an earphone is connected between said signal amplifier and said speaker.

3. The voice barcode scan device recited in claim 1, wherein said voice-processing unit connects to a voice-input unit, said voice-input unit consists of a microphone, a signal amplifier and a voice-input interface, said voice-input unit inputs and stores the voice signals into the memory unit.
